(19) United States
(12) Patent Application Publication
(10) Pub. No.: US 2007/0058040 A1
(43) Pub. Date: Mar. 15, 2007

(54) Video surveillance using spatial-temporal motion analysis

(75) Inventors: Zhong Zhang, Herndon, VA (US); Niels Haering, Reston, VA (US); Alan J. Lipton, Herndon, VA (US); Haiying Liu, Chantilly, VA (US); Peter L. Venetianer, McLean, VA (US); Weihong Yin, Herndon, VA (US); Li Yu, Herndon, VA (US)

Correspondence Address: VENABLE LLP, P.O. BOX 34385, WASHINGTON, DC, 20043-9998, US

(73) Assignee: ObjectVideo, Inc., Reston, VA (US)

(21) Appl. No.: 11/221,923

(22) Filed: Sep. 9, 2005

(51) Int. Cl. H04N 7/18

(52) U.S. Cl. 348/150

(57) ABSTRACT

Detection of an omitted process in an event having of a sequence of processes includes: receiving video of an action area; receiving transaction data regarding a transaction occurring at the action area; detecting at least two different actor motion states in the video; detecting an event based on the motion states; and detecting the omitted process based on the detected event and the transaction data.

### BACKGROUND OF THE INVENTION

1. Field of the Invention

This invention generally relates to surveillance systems. Specifically, the invention relates to a video-based surveillance system that can be used for retail store lost prevention, for example, to detect “free bagging” at a checkout counter.

2. Related Art

Some state-of-the-art intelligent video surveillance (IVS) systems can perform content analysis on frames generated by surveillance cameras. Based on user-defined rules or policies, IVS systems may be able to automatically detect potential threats by detecting, tracking and analyzing the targets in the scene. One significant constraint of the system is that the targets have to be isolated in the camera views. Existing IVS systems have great difficulty in tracking individual targets in a crowd situation, mainly due to target occlusions. For the same reason, the types of targets that a conventional IVS system can distinguish are also limited.

In many situations, security needs demand much greater capabilities from an IVS. One example is the loss prevention from the retail industry. According to a recently released National Retail Security Survey conducted by University of Florida, United States retailers lost between 20 and 30 billion dollars per year due to theft from stores, including employee and vendor theft. Employee theft and shoplifting combined account for the largest source of property crime committed annually, where employee theft alone accounts for more than 44 percent of all retail losses in the United States.

The existing methods to deter employee theft include using video surveillance of sales associates, especially those working at cash registers; performing systematic background screening of job applicants; paying higher wages to hire and retain more dedicated employees, and improving job satisfaction levels of retail sales associates.

Studies also show that one effective theft prevention method is to increase security. Although many stores have video surveillance cameras installed, most of them just serve as forensic tape providers. Intelligent real-time theft detection capability is highly desired but is not conventionally available.

One type of employee theft stores often encounter is called “free-bagging,” which means the cashier at the checkout counter bags the merchandise without actually checking it out by scanning the barcode or typing in the price. This type of theft is very difficult to detect even by watching the surveillance videos.

### SUMMARY OF THE INVENTION

Embodiments of the invention include a method, a system, an apparatus, and an article of manufacture for automatic “free-bagging” detection. Such embodiments may involve computer vision techniques to automatically detect “free-bagging” and other such events by detecting and tracking the cashier and analyzing the cashier's movement. This spatial-temporal video target motion analysis technique is not limited to the store theft detection applications, but may also be used in other scenarios, for example, those in which the target of interest performs some repeated sequence of operations. Examples of such repeated sequence operations may include: actions on an assembly line; actions on a factory floor; actions at a casino; actions at a border patrol checkpoint; and actions at a passport entry checkpoint.

Embodiments of the invention may include a machine-accessible medium containing software code that, when read by a computer, causes the computer to perform a method for detecting a free-bagging event. The method includes receiving video of a checkout area; receiving point of sale (POS) data regarding a transaction occurring at the checkout area; detecting at least two different cashier motion states in the video; detecting a checkout event based on the cashier motion states; and detecting a free-bagging event based on the detected checkout event and the POS data.

Another embodiment of the invention may include a machine-accessible medium containing software code that, when read by a computer, causes the computer to perform a method for detection of an omitted process in an event comprised of a sequence of processes. The method may include: receiving video of an action area; receiving transaction data regarding a transaction occurring at the action area; detecting at least two different actor motion states in the video; detecting an event based on the motion states; and detecting the omitted process based on the detected event and the transaction data.

A system used in embodiments of the invention may include a computer system including a computer-readable medium having software to operate a computer in accordance with embodiments of the invention.

An apparatus according to embodiments of the invention may include a computer including a computer-readable medium having software to operate the computer in accordance with embodiments of the invention.

An apparatus according to the invention may include application-specific hardware to emulate a computer and/or software in accordance with embodiments of the invention.

An article of manufacture according to embodiments of the invention may include a computer-readable medium having software to operate a computer in accordance with embodiments of the invention.

Exemplary features of various embodiments of the invention, as well as the structure and operation of various embodiments of the invention, are described in detail below with reference to the accompanying drawings.

### BRIEF DESCRIPTION OF THE DRAWINGS

The foregoing and other features of various embodiments of the invention will be apparent from the following, more particular description of such embodiments of the invention, as illustrated in the accompanying drawings, wherein like reference numbers generally indicate identical, functionally similar, and/or structurally similar elements. The left-most digits in the corresponding reference number indicate the drawing in which an element first appears.

FIG. 1 depicts a typical application scenario for some embodiments of the invention;

FIG. 2 depicts a conceptual block diagram of a free bagging detection system according to some embodiments of the invention;

FIG. 3 illustrates an example camera setup according to some embodiments of the invention;

FIG. 4 depicts a conceptual block diagram of the free bagging detection algorithm according to some embodiments of the invention;

FIG. 5 depicts a block diagram of an instant cashier state detection module according to some embodiments of the invention;

FIG. 6 illustrates the potential cashier instant states according to some embodiments of the invention;

FIG. 7 depicts a block diagram of detecting a checkout event according to some embodiments of the invention;

FIG. 8 depicts a block diagram of detecting individual checkout processes according to some embodiments of the invention;

FIG. 9 depicts a block diagram of a PICKINGUP process detection module according to some embodiments of the invention;

FIG. 10 depicts a block diagram of a SCANNING process detection module according to some embodiments of the invention;

FIG. 11 depicts a block diagram of a BAGGING process detection module according to some embodiments of the invention;

FIG. 12 depicts a block diagram of checkout state monitoring and overall checkout event detection module according to some embodiments of the invention;

FIG. 13 depicts a block diagram of a free-bagging event detection module according to some embodiments of the invention;

### DEFINITIONS

The following definitions are applicable throughout this disclosure, including in the above.

“Video” may refer to motion pictures represented in analog and/or digital form. Examples of video may include television, movies, image sequences from a camera or other observer, and computer-generated image sequences. Video may be obtained from, for example, a live feed, a storage device, an IEEE 1394-based interface, a video digitizer, a computer graphics engine, or a network connection.

A “video camera” may refer to an apparatus for visual recording. Examples of a video camera may include one or more of the following: a video camera; a digital video camera; a color camera; a monochrome camera; a camera; a camcorder; a PC camera; a webcam; an infrared (IR) video camera; a low-light video camera; a thermal video camera; a closed-circuit television (CCTV) camera; a pan, tilt, zoom (PTZ) camera; and a video sensing device. A video camera may be positioned to perform surveillance of an area of interest.

A “frame” may refer to a particular image or other discrete unit within a video.

A “region” may refer a particular area on a video frame

An “object” may refer to an item of interest in a video. Examples of an object may include: a person, a vehicle, an animal, and a physical subject.

A “target” may refer to the computer's model of an object. The target is derived from the image processing, and there is a one-to-one correspondence between targets and objects. The target in some exemplary embodiments of the invention may be a shopping cart.

A “checkout event” may refer to one entire process of merchandise checkout, which may include picking up the item from the conveyer belt or counter, scanning the barcode or typing in the price of the item, and putting the item on the bagging side of the counter or bagging the item.

A “checkout process” may refer to one component of a “checkout event,” such as picking up the item, scanning the item or bagging the item.

A “POS system” may refer to a point of sale retail system which may include a computer system with software, a barcode scanner, a card reader, a printer, a keyboard, a monitor, a cash drawer and/or other components.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor or multiple processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a personal digital assistant (PDA); a portable telephone; application-specific hardware to emulate a computer and/or software, such as, for example, a digital signal processor (DSP) or a field-programmable gate array (FPGA); a distributed computer system for processing information via computer systems linked by a network; two or more computer systems connected together via a network for transmitting or receiving information between the computer systems; and one or more apparatus and/or one or more systems that may accept data, may process data in accordance with one or more stored software programs, may generate results, and typically may include input, output, storage, arithmetic, logic, and control units.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a memory chip; and a carrier wave used to carry computer-readable electronic data, such as those used in transmitting and receiving e-mail or in accessing a network.

“Software” may refer to prescribed rules to operate a computer. Examples of software may include software; code segments; instructions; computer programs; and programmed logic.

A “computer system” may refer to a system having a computer, where the computer may include a computer-readable medium embodying software to operate the computer.

A “network” may refer to a number of computers and associated devices that may be connected by communication facilities. A network may involve permanent connections such as cables or temporary connections such as those made through telephone or other communication links. Examples of a network may include: an internet, such as the Internet; an intranet; a local area network (LAN); a wide area network (WAN); and a combination of networks, such as an internet and an intranet.

### DETAILED DESCRIPTION OF EMBODIMENTS OF THE PRESENT INVENTION

Exemplary embodiments of the invention are discussed in detail below. While specific exemplary embodiments are discussed, it should be understood that this is done for illustration purposes only. A person skilled in the relevant art will recognize that other components and configurations can be used without parting from the spirit and scope of the invention.

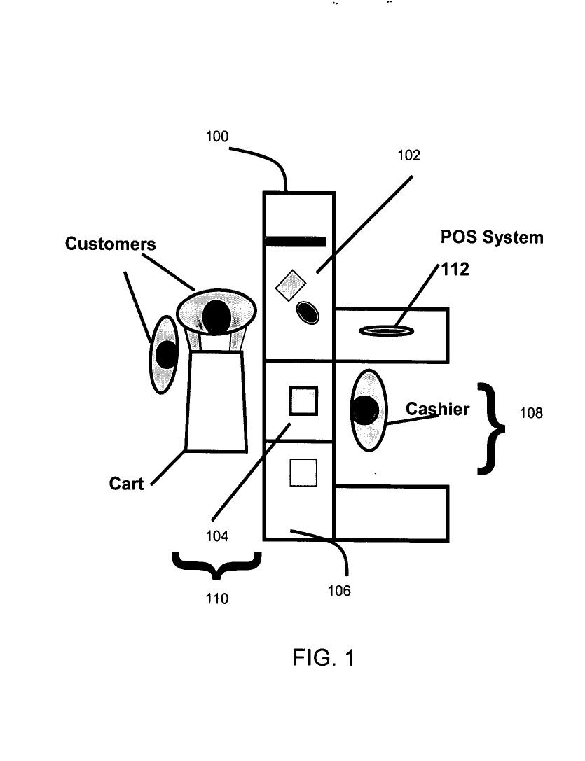

FIG. 1 depicts an exemplary application scenario for embodiments of the present invention, namely, a checkout area of a retail store. The checkout area may include a checkout counter 100, including a conveyer belt desk 102, a scanning desk 104 and a bagging desk 106. The right side of the checkout counter may include a cashier area 108, and a left side may include a customer area 110. The cashier may interact with a POS system 112. A conventional closed-circuit television (CCTV) camera will not perform any advanced analysis on the scene, and even with constant human observation of the video, it may be difficult to determine if the cashier successfully scanned the barcode or just moved the merchandise over the scanner window without actually scanning it. State-of-the-art existing IVS systems are not able to fulfill this task either, due to a number of constraints, including a busy background and crowded foreground. These constraints make it difficult to separate out individual targets and then further analyze their properties and track their moving trajectories. Embodiments of the present invention may provide a solution to this problem, which may detect each checkout event by a spatial-temporal motion state analysis and further detect the free bagging event by comparison with POS data. Embodiments of the present invention are not limited to the arrangement of the checkout counter 100, but may be applied to other arrangements of a checkout counter, including, for example, a checkout counter where there is no cashier. At a self-checkout counter, the customer may be monitored in the same way as a cashier. Further, embodiments of the present invention are not limited to the cashier checkout scenario, but may be applied to other situations where it desirable to monitor a person who performs repetitive movements, such as, e.g., a worker on an assembly line, a worker on a factory floor, a dealer at a casino, an officer at a border patrol checkpoint, or an officer at a passport entry checkpoint.

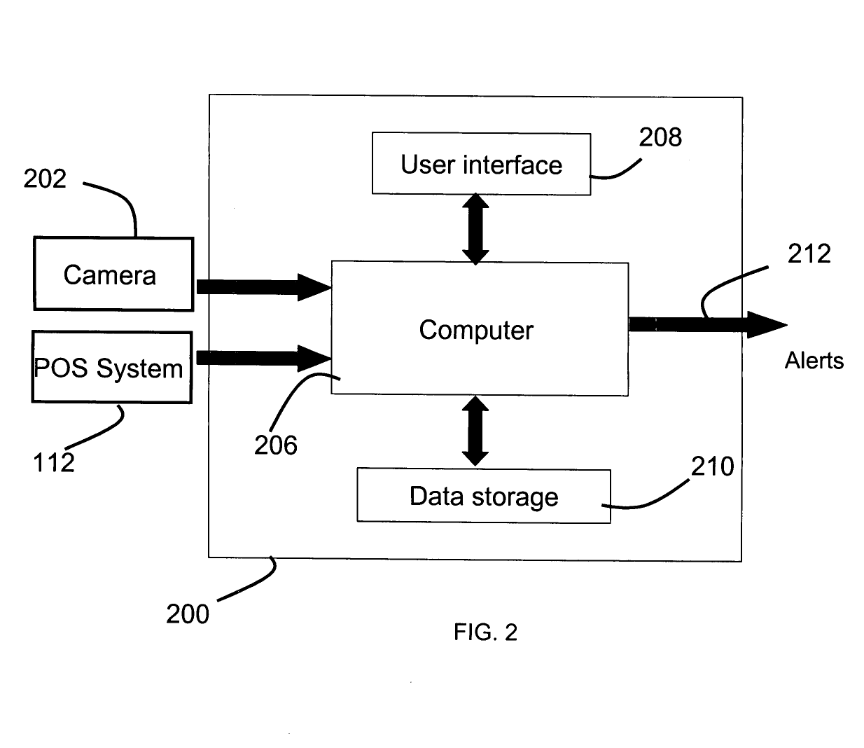

FIG. 2 depicts a conceptual block diagram of an embodiment of an inventive free-bagging detection IVS system 200. A video camera 202 may have an overhead placement over the checkout counter 100. Other types of cameras and other placements may be used. POS system 112 may feed transaction data into the system 200. A computer 206 may perform scene content analysis. The inputs to the computer 206 may include the video signals from camera 202 and the transaction data from POS system 112. The user may set up the system through the user interface 208. Once any event is detected, alerts 212 may be sent to appropriate destinations (for example, but not limited to, staff, police, etc.). Such alerts may be furnished with necessary information and/or instructions for further attention and investigations. The video data, scene context data, and/or other event related data may be stored in a data storage apparatus 210 for later forensic analysis. The data storage apparatus 210 may be, for example, a computer-readable medium.

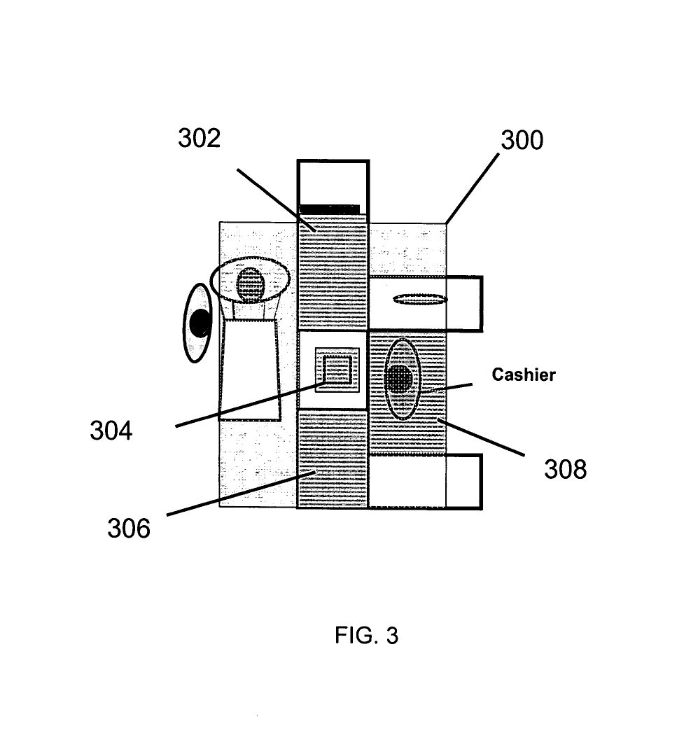

FIG. 3 illustrates an exemplary setup of the surveillance camera 202. The camera 202 may be placed directly above the center of the checkout counter 100, or above the scanning desk 104 and looking down at the entire checkout area, including checkout counter 100, customer area 110, and cashier area 108. The camera height and focal length may be adjusted such that most of the checkout area can be seen. The camera 202 may have sample camera field of view 300. Once the camera 202 is setup, the user may need to define several regions of interest through the user interface 208: e.g., a conveyer belt region 302, a scanner window region 304, a bagging region 306, and a cashier region 308. These regions may be defined directly based on the actual checkout counter setup displayed in the camera view. In addition to the above regions of interest, the approximate cashier target size may also be obtained either by user input, for example, using the approximate radius, or by a camera calibration method. Based on the approximate cashier image radius Cr, the area range of a potential cashier target may be defined as:
CashierArea_{Min}=π*Cᵣ*Cᵣ/2
CashierArea_{Max}=2*π*Cᵣ*Cᵣ

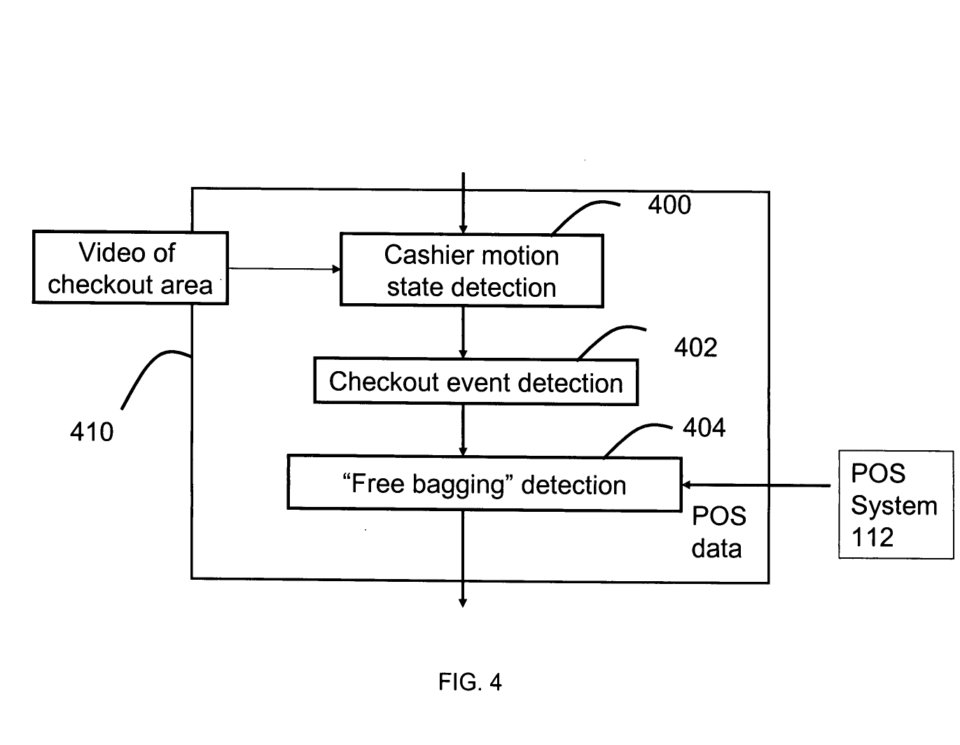

FIG. 4 depicts a conceptual block diagram of an embodiment of an inventive free-bagging detection technique 410 implemented by the computer 206. The video signal from camera 202 may be fed into module 400 for computer vision based scene analysis, which may detect the cashier's position and the cashier's motion state in each video frame. Based on these cashier motion states, module 402 may further detect each complete checkout event. Once any checkout event is detected, module 404 may compare the transaction data from the POS system 112 to determine whether the detected checkout event is a valid checkout transaction or a potential free bagging event. The detection of a potential free-bagging event may initiate an alert 212.

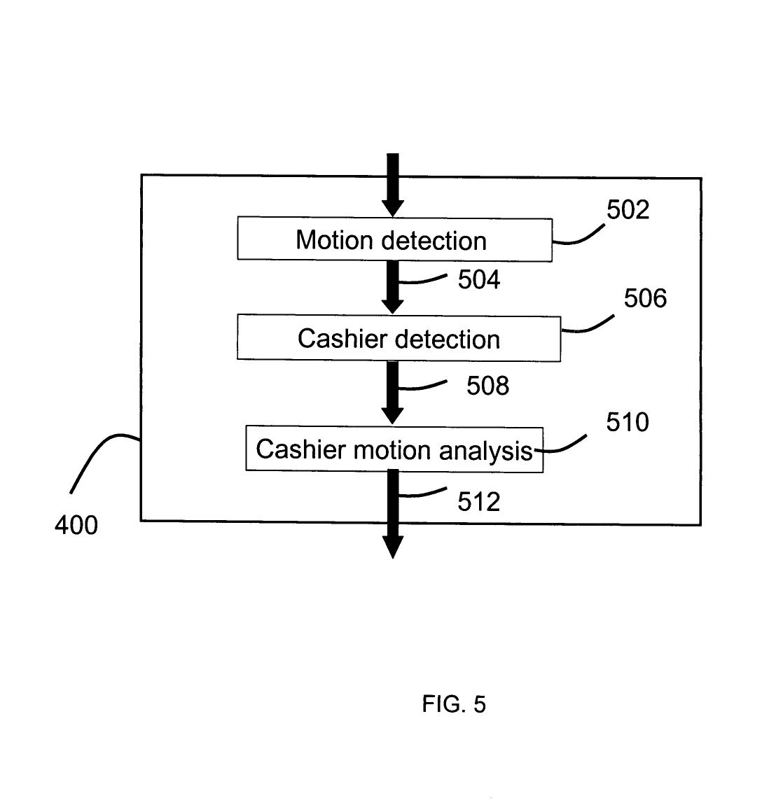

FIG. 5 depicts a block diagram for the cashier motion state detection of block 400. A motion detection module 502 may be used to detect any motion pixels 504 in each video frame. Motion detection algorithms are widely available in the computer vision field to perform this task. Next, a cashier target detection module 506 may be used to locate the cashier in the scene, if there is one. Only cashiers with movements are of interest; therefore, only motion pixels may be used for this purpose. The motion pixels may be first turned into individual “blobs” using a connect component analysis method, for example, the method used in “Video Surveillance System,” U.S. Patent Application Publication No. 2005/0162515, which is incorporated herein by reference. The obtained blobs may contain the following blob information, for example: centroid location, bounding box and area. The cashier detection module 506 may then search the list of detected blobs to find any blobs satisfying the following criteria, for example: the centroid of the blob is inside the cashier region, or the total area of the blob which is inside the cashier region is within the range of the cashier area. Once a cashier target 508 is detected, a cashier motion analysis module 510 may be used to determine the motion state of the cashier 512.

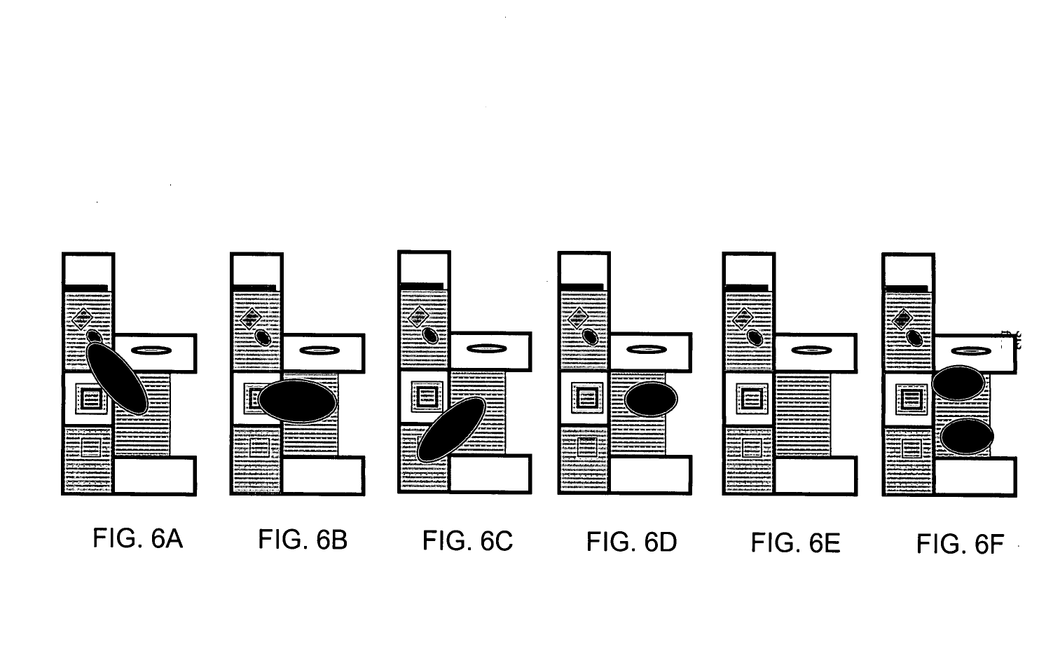

FIGS. 6A-6F illustrate possible cashier motion states 512 that may be determined. If it is desirable for the system to detect every checkout event that contains a sequence of ordered operations, the cashier's motion state 512 may be defined by five instant states of interest. For example:

“PICKINGUP” motion state: the cashier is picking up items from the conveyer region as illustrated in FIG. 6A;

“SCANNING” motion state: the cashier is scanning the barcode of the picked item as illustrated in FIG. 6B;

“BAGGING” motion state: the cashier is putting down the item at the bagging area or is bagging the item as illustrated in FIG. 6C;

“TRANSITION” motion state: the cashier is in the cashier area but is not in any of the above state as illustrated in FIG. 6D;

“NOTCARE” motion state: there is no cashier in the cashier area, or there are multiple cashiers in the cashier area, as illustrated in FIGS. 6E and 6F, respectively.

Other motion states and sets of motion states may be determined based on the operations being observed and/or the physical layout of the observed area.

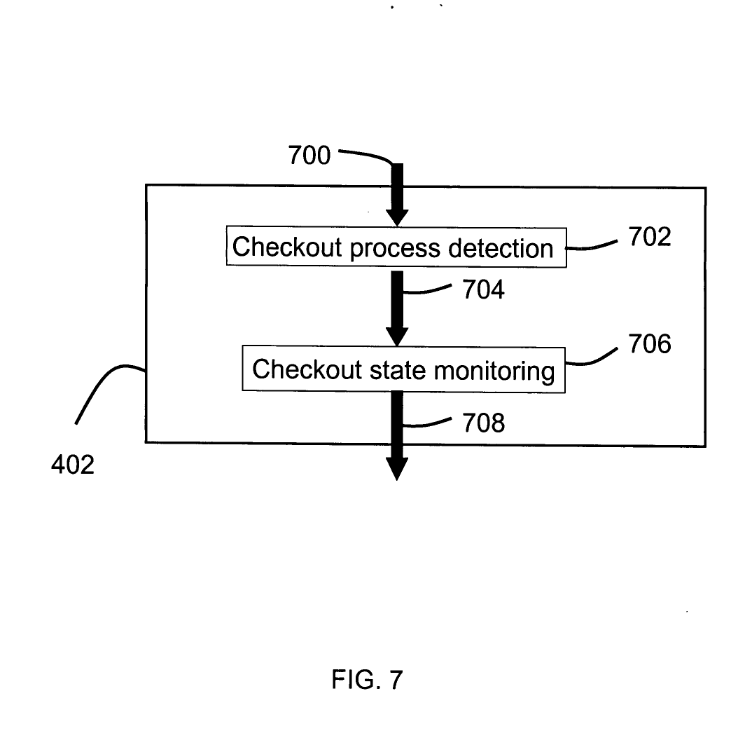

FIG. 7 depicts a block diagram of detecting a checkout event for block 402. The input 700 to the checkout process detection module 702 may be a sequence of cashier motion states 512. A complete exemplary checkout event observed from the video may contain three ordered processes: the “PICKINGUP” checkout process, the “SCANNING” checkout process and the “BAGGING” checkout process. The SCANNING checkout process may include bar code scanning, manual entry of price, or other methods of item price entry into POS system 112. Module 702 may be used to detect if the cashier has completed any of these three checkout processes. The detected checkout process 704 may be fed into a checkout state monitoring module 706 to detect if an entire checkout event 708 is completed.

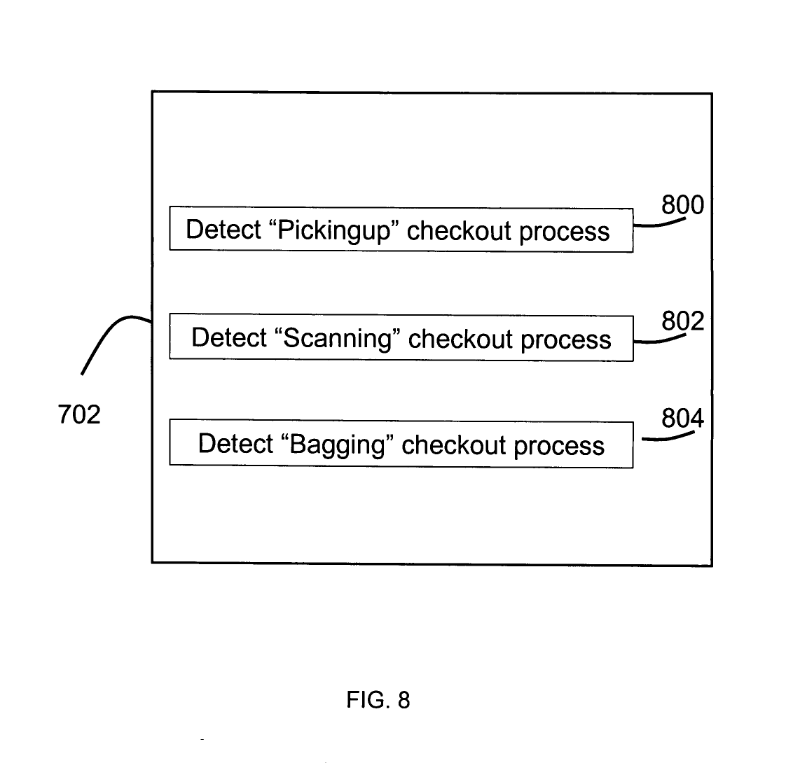

FIG. 8 depicts three individual checkout process detection modules for checkout process detection module 702. The module 800 may detect if the cashier has performed a PICKINGUP checkout process. The module 802 may detect if the cashier has performed a SCANNING checkout process. The module 804 may detect if the cashier has performed a BAGGING checkout process.

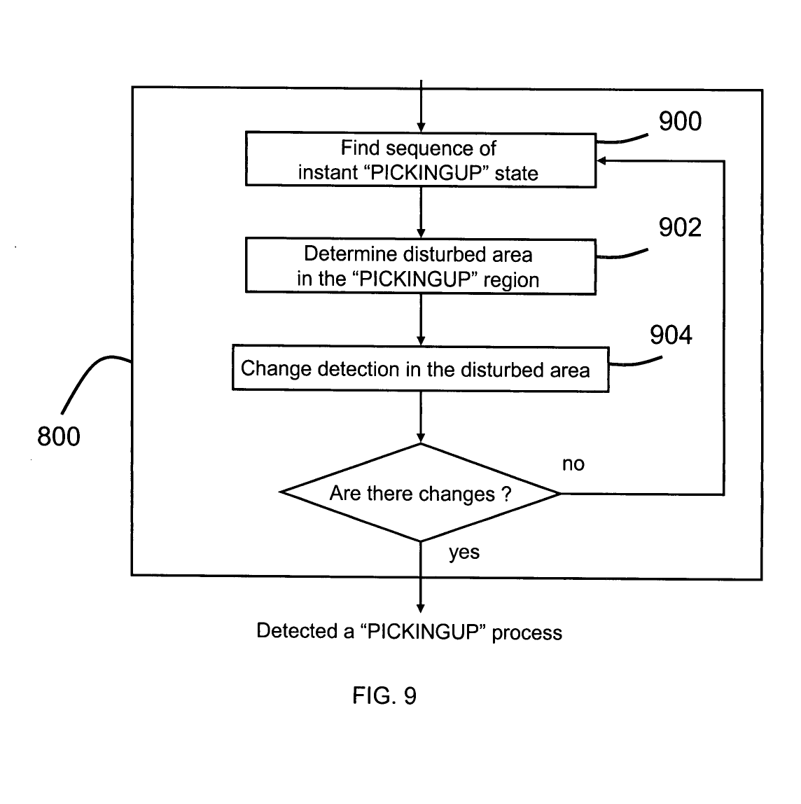

FIG. 9 depicts a block diagram to detect a PICKINGUP checkout process for module 800. Module 900 may search a list of cashier motion states 512 to see if there is a list of consecutive PICKINGUP motion states. The list of the N consecutive states may both start and end with a non-PICKINGUP motion state. For example, for N consecutive frames, in frames 1 and N, the cashier is not in the PICKINGUP motion state, and in frames 2 through N−1, the cashier is in the PICKINGUP motion state. Module 902 may determine the disturbed area in the PICKINGUP region during frames 2 to N−1. The disturbed area may be detected by a performing a logical OR operation on all the motion masks from frames 2 through N−1. In other words, a pixel location in the PICKINGUP region may be marked as disturbed if, in any frame between frames 2 and N−1, the corresponding pixel is detected as a moving pixel by the motion detector. All of the disturbed pixels may form the disturbed area which can be represented by a binary image mask. Next, module 904 may compare frame 1 and frame N to determine if there is any change within the disturbed area in the PICKINGUP region, which may correspond to the conveyor belt region 302. The change may be detected by computing the pixel difference between the two frames. A change pixel may be the image location that the difference is bigger than a threshold. The threshold may be a pre-determined value or the average image difference times a multiplication factor. Any changes may indicate that the cashier just completed a PICKINGUP checkout process. The change area may actually indicate the item that was picked up. If there is no change detected, the module may go back to 900 to find the next list of consecutive PICKINGUP motion states.

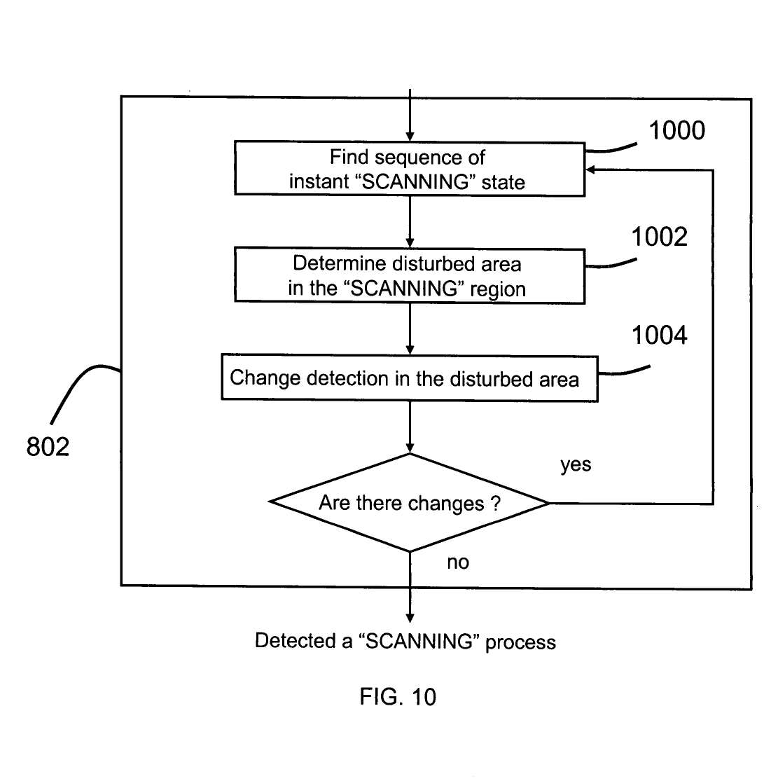

FIG. 10 depicts a block diagram to detect a “SCANNING” process for module 800. Detecting a SCANNING process is similar to detect the PICKINGUP process as described above for FIG. 9. Module 1000 may detect a list of consecutive SCANNING motion states. Module 1002 may determine the disturbed area in the SCANNING region, which may correspond to scanner window region 304, and module 1004 may detect if there is any change in the disturbed area before and after the SCANNING process. In this case, no change in the distributed area may be considered as a complete SCANNING process.

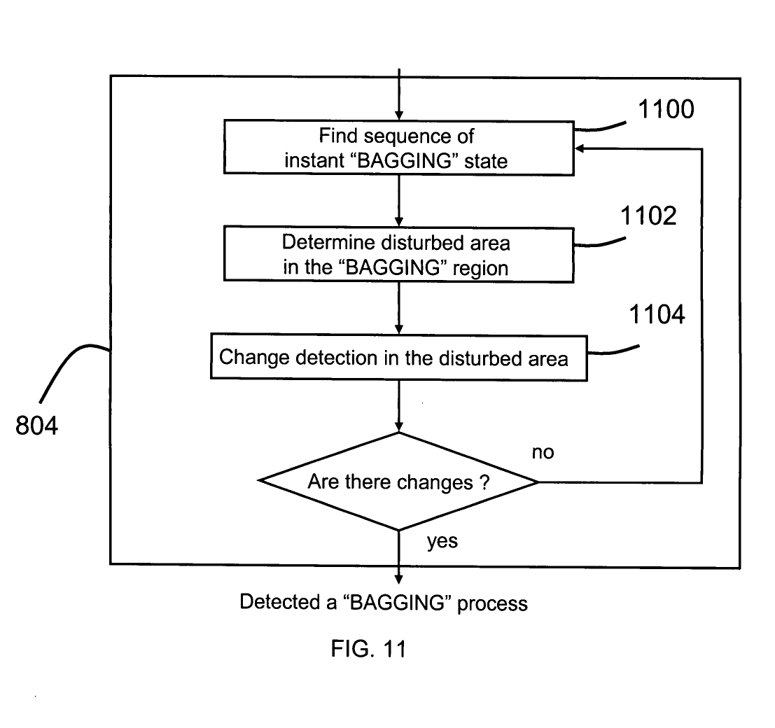

FIG. 11 depicts a block diagram on how to detect a “BAGGING” process for module 804. Detecting a BAGGING process is similar to detecting a PICKINGUP process as described above for FIG. 9. Module 1100 may detect a list of consecutive BAGGING states. Module 1102 may determine the disturbed area in the BAGGING region 306, and module 1104 may detect if there is any change in the disturbed area in the BAGGING region 306. Any detected change area may indicate the handled item and further confirm that the cashier has completed a BAGGING process.

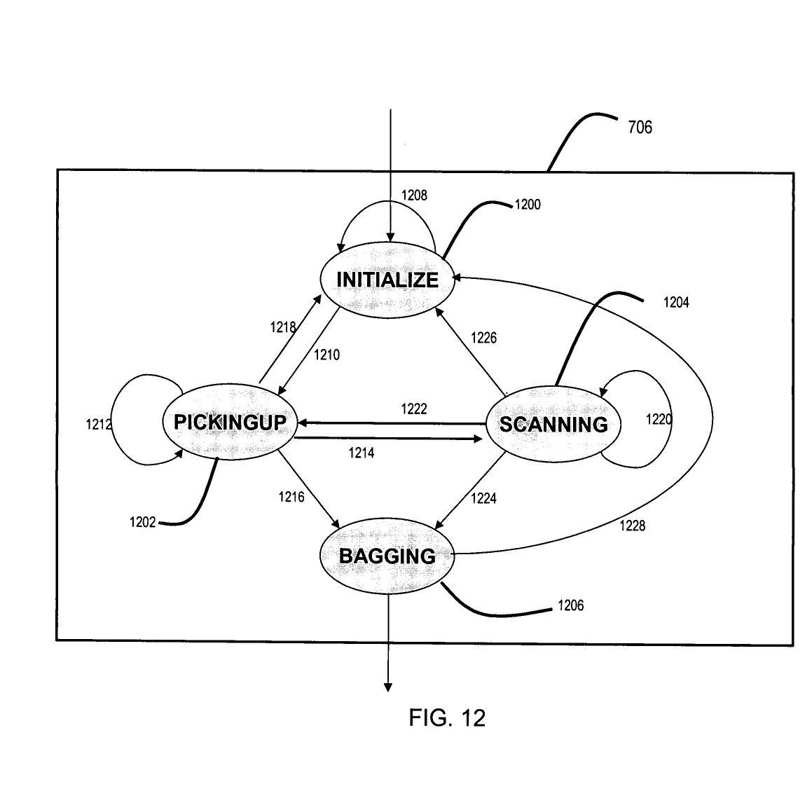

FIG. 12 depicts a state diagram of checkout state monitoring in module 700 and checkout event detection in module 402. Here, the entire checkout event may be represented as a finite state machine (FSM). There are four states in the exemplary FSM:

“INITIALIZE” state 1200: which may indicate that the cashier is not in a checkout process.

“PICKINGUP” state 1202: which may indicate that the cashier may be in a checkout process and the cashier has completed the PICKINGUP process;

“SCANNING” state 1204: which may indicate that the cashier may be in a checkout process and the cashier has completed both the PICKINGUP process and the SCANNING process;

“BAGGING” state 1206: which may indicate that the cashier may have completed an entire checkout process.

The transitions from state to state in the FSM are as follows:

Transition 1208: “INITIALIZE”→“INITIALIZE”: no PICKINGUP process may be detected by module 800;

Transition 1210: “INITIALIZE”→“PICKINGUP”: a PICKINGUP process may be detected by module 800;

Transition 1212: “PICKINGUP”→“PICKINGUP”: no SCANNING or BAGGING process may be determined by module 802 or 804, respectively;

Transition 1214: “PICKINGUP”→“SCANNING”: a SCANNING process may be detected by module 802;

Transition 1216: “PICKINGUP”→“BAGGING”: a BAGGING process may be detected by module 804;

Transition 1218: “PICKINGUP”→“INITIALIZE”: a NOTCARE motion state may be detected by module 400 or the cashier may be in the PICKINGUP state 1202 longer than a timeout threshold. The timeout threshold may be a time duration that is much longer than a typical checkout process may take.

Transition 1220: “SCANNING”→“SCANNING”: no PICKINGUP or BAGGING process may be detected by module 800 or 804, respectively;

Transition 1222: “SCANNING”→“PICKINGUP”: a PICKINGUP process may be detected by module 800;

Transition 1224: “SCANNING”→“BAGGING”: a BAGGING process may be detected by module 804;

Transition 1226: “SCANNING”→“INITIALIZE”: a NOTCARE motion state may be detected by module 400 or the cashier may be in the PICKINGUP state 1202 longer than a timeout threshold. The timeout threshold may be a time duration that is much longer than a typical checkout process may take.

Transition 1228: “BAGGING”→“INITIALIZE”: Once the FSM enters into the BAGGING state 1206, a checkout event may be triggered, and the FSM may immediately go back to INITIALIZE state 1200 to detect the next potential checkout process.

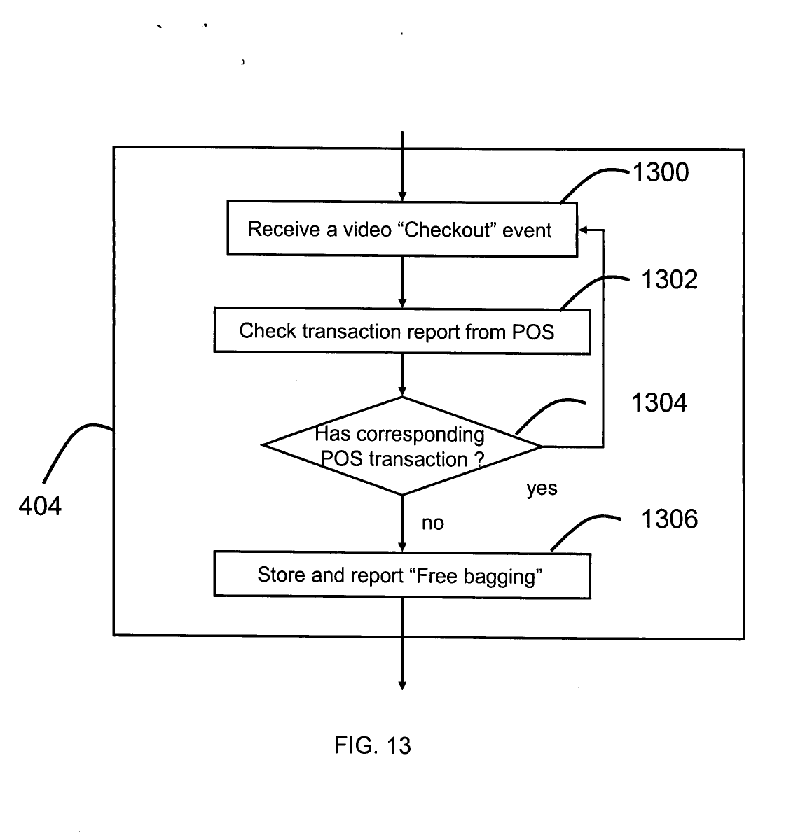

FIG. 13 depicts a block diagram for free-bagging event detection in module 404. Module 1300 monitors the checkout event detection module 402, once module 1300 detects a checkout event, module 1302 may search the transaction data from the POS system 112 to determine if there is at least one matching transaction. A matching POS transaction may be a transaction from the POS system 112 triggered, for example, either by a barcode received by the barcode scanner or by cashier input from the keyboard. The transaction time must be within the time period of the checkout event detected by module 402. If there is no matching POS transaction found, the detected checkout event may be a free-bagging event, which may be reported to the designated parties via an alert 212 and stored in the data storage apparatus 210 for future reference or further analysis.

Further processing may be performed using the free-bagging event to obtain further conclusions. For example, the system may provide statistics on the free-bagging event on any cashier with any time duration. If one cashier is detected triggering a free-bagging event once in a month, it may not be convincing evidence to make any conclusions. However, if another cashier is detected to trigger the free bagging event ten times a week, the manager may be alerted.

The techniques described herein are not limited to the detection of theft at a store checkout counter, but may be applied analogously to monitor for omitted processes in situations where transactions occurring in an action area are monitored, for example, by video, and where an actor in the action area engages in a transaction made up of a sequence of repeated motions.

The computer vision techniques described herein are general and may be used in detecting video activities that involve some fixed spatial locations that include a sequence of ordered operations. For example, the invention may be used to detect any activities in a surveillance video that have the following two properties. First, the activity may consist of a sequence of ordered operations. For example, in the checkout counter monitoring application discussed above, the checkout activity consists of the ordered operations of picking up an item, scanning a barcode or typing in a price for the item, and bagging the item. Second, the operations are performed by the same actor and at some fixed video image locations. For example, in the checkout counter monitoring application, all the operations may be performed by the same cashier, and each operation may be performed at a designated area. Once these two conditions are satisfied in an application scenario, one of ordinary skill may use the described spatial-temporal motion analysis described herein to detect the activity of interest in the video stream.

In general, the spatial-temporal motion analysis of the invention may contain the following three steps. First, setup the surveillance camera such that all of the regions in which the operations may occur are visible and may be easily defined. Second, detect the potential target of interest in the corresponding region and determine its instant motion state using the spatial location information and motion analysis. Third, use a temporal state transition analysis method, such as a FSM, to detect the complete activity process.

The exemplary modules discussed herein may be implemented in hardware and/or software.

The embodiments and examples discussed herein should be understood to be non-limiting examples.

The invention is described in detail with respect to preferred embodiments, and it will now be apparent from the foregoing to those skilled in the art that changes and modifications may be made without departing from the invention in its broader aspects, and the invention, therefore, as defined in the claims is intended to cover all such changes and modifications as fall within the true spirit of the invention.

1. A machine-accessible medium containing software code that, when read by a computer, causes the computer to perform a method for detecting a free-bagging event, the method comprising:
receiving video of a checkout area;
receiving point of sale (POS) data regarding a transaction occurring at the checkout area;
detecting at least two different cashier motion states in the video;
detecting a checkout event based on the cashier motion states; and
detecting a free-bagging event based on the detected checkout event and the POS data.

2. The machine-accessible medium containing software code of claim 1, wherein detecting a cashier motion state comprises performing motion detection and change detection on the video.

3. The machine-accessible medium containing software code of claim 2, wherein detecting a cashier motion state further comprises determining one of a picking-up motion state, a scanning motion state, or a bagging motion state.

4. The machine-accessible medium containing software code of claim 1, wherein detecting the checkout event comprises:
detecting a checkout process; and
detecting whether the checkout event is complete.

5. The machine-accessible medium containing software code of claim 4, wherein detecting the checkout process comprises detecting at least one of a picking-up checkout process, a scanning checkout process, or a bagging checkout process.

6. The machine-accessible medium containing software code of claim 5, wherein detecting whether the checkout event is complete comprises:
monitoring a transition from a detected picking-up checkout process, a detected scanning checkout process, or a detected bagging checkout process to another detected checkout process; and
detecting that the checkout event is complete when a transition to a bagging checkout process is monitored.

7. The machine-accessible medium containing software code of claim 1, wherein detecting the free-bagging event based on the detected checkout event and the POS data comprises:
examining the POS data for the transaction upon detection of the checkout event; and
triggering a free-bagging alert when the POS data does not contain the transaction corresponding to the detected checkout event.

8. A video-surveillance system for detecting free-bagging comprising:
a video source;
a point of sale (POS) system; and
an apparatus receiving input from the video source and from the POS system, and adapted to detect free-bagging at a point of sale location.

9. The video surveillance system of claim 8, further comprising:
a user interface coupled to the apparatus; and
a data storage apparatus coupled to the apparatus.

10. The video surveillance system of claim 8, wherein the apparatus is further adapted to detect at least two different cashier motion states in the video, to detect a checkout event based on the cashier motion states; and to detect a free-bagging event based on the detected checkout event and the input received from the POS system.

11. The video surveillance system of claim 8, wherein the apparatus comprises a computer having software to detect free-bagging.

12. The video surveillance system of claim 8, wherein the apparatus comprises application-specific hardware adapted to detect free-bagging.

13. A machine-accessible medium containing software code that, when read by a computer, causes the computer to perform a method for detection of an omitted process in an event comprised of a sequence of processes, the method comprising:
receiving video of an action area;
receiving transaction data regarding a transaction occurring at the action area;
detecting at least two different actor motion states in the video;
detecting an event based on the motion states; and
detecting the omitted process based on the detected event and the transaction data.

14. A video-surveillance system for detecting an omitted process comprising:
a video source;
a system adapted to record data regarding an event occurring in a defined area; and
an apparatus receiving input from the video source and from the system, and adapted to detect the omitted process.

15. The video surveillance system of claim 14, wherein the apparatus comprises a computer having software to detect free-bagging.

16. The video surveillance system of claim 14, wherein the apparatus comprises application-specific hardware adapted to detect free-bagging.

17. A computer-implemented method for detecting a free-bagging event, comprising:
receiving video of a checkout area;
receiving point of sale (POS) data regarding a transaction occurring at the checkout area;
detecting at least two different cashier motion states in the video;
detecting a checkout event based on the cashier motion states; and
detecting a free-bagging event based on the detected checkout event and the POS data.
